(19) United States
(12) Patent Application Publication
(10) Pub. No.: US 2025/0252284 A1
(43) Pub. Date: Aug. 7, 2025

(54) SYSTEMS AND METHODS FOR TRAINING A LEARNING MODEL TO PREDICT A CYCLING CHARACTERISTIC USING A PHYSICS MODEL

(71) Applicant: Toyota Motor Engineering & Manufacturing North America, Inc., Plano, TX (US)

(72) Inventors: Alexander T. Pham, San Jose, CA (US); Nathan Sun, Greer, SC (US); Karena Yan, Morganville, NJ (US); Sara Sameer, Karachi (PK); Constantin-Daniel Nicolae, Mangalia (RO)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/619,815

(22) Filed: Mar. 28, 2024

Related U.S. Application Data
(60) Provisional application No. 63/627,925, filed on Feb. 1, 2024.

(51) Int. Cl. G06N 3/04

(52) U.S. Cl. CPC G06N 3/04

(57) ABSTRACT

Systems, methods, and other embodiments described herein relate to training a learning model to predict a cycling characteristic of a battery using a physics model. In one embodiment, a method includes deriving ground-truth parameters for a loss curve of an actual capacity using a physics model, the actual capacity associated with a battery type. The method also includes comparing the ground-truth parameters with curve parameters estimated by a self-attention model for physical tuning of the self-attention model, and the curve parameters being associated with a predicted capacity for the battery type. The method also includes adjusting the self-attention model by comparing predicted cycles from the self-attention model and actual cycles from the physics model for cycle life as additional tuning.

### CROSS-REFERENCE TO RELATED APPLICATIONS

This application claims the benefit of U.S. Provisional Application No. 63/627,925, filed on, Feb. 1, 2024, which is herein incorporated by reference in its entirety.

### TECHNICAL FIELD

The subject matter described herein relates, in general, to training a learning model using a physics model for a battery, and, more particularly, training the learning model to predict a cycling characteristic of the battery using the physics model.

### BACKGROUND

Electronic devices are increasingly relying on batteries for power. Sourcing energy from batteries helps the environment since battery power can avoid using fossil fuels. Furthermore, systems can recharge batteries to reduce disposal waste. However, battery chemistry and degradation limit the amount that systems can recharge batteries. For instance, a cycle life is the number of charge and discharge cycles that a battery can complete before losing performance. In particular, discharge parameters (e.g., depth) can explain how a device and battery operation are associated with a cycle life. For example, the cycle life of a lithium-ion (Li-ion) battery is affected by a discharge depth that defines the storage capacity utilized during various operating conditions. As such, estimating a cycle life and related characteristics for a battery can assist device operation by optimizing charging and recharging.

In various implementations, a learning model (e.g., a neural network) can predict cycle life of a battery and assist with optimization. However, systems training the learning model for different devices and battery types can encounter difficulties with cycle life predictions. For example, a vehicle using a Li-ion battery exhibits a different operating paradigm than a laptop computer using a lithium-polymer (Li—Po) battery from exposure to weather conditions that are extreme. In particular, battery types have physical characteristics (e.g., capacity loss) that behave differently during cycling (e.g., a rapid recharge) and temperature variances (e.g., extreme cold). Furthermore, acquiring data about the physical characteristics (e.g., interphase formations) of batteries for training can be costly when scaled. Therefore, training a learning model to predict cycle life of a battery accurately faces difficulties from profiling and acquiring data about physical phenomena.

### SUMMARY

In one embodiment, example systems and methods are associated with training a learning model to predict a cycling characteristic of a battery using a physics model. In various implementations, systems measuring cycle life of batteries (e.g., lithium-ion (Li-ion)) rely on accurate results for performance and technology development. A learning model can predict cycle life when trained with diverse data representing the physical characteristics and phenomena about a battery. However, systems at times retrain learning models that predict cycle life due to end-of-life distortions and physical breakdown, such as current degradation and interphase formations initially uncaptured by training data. Furthermore, a learning model can lack interpretability about internal mechanics and methodology when predicting cycle life, thereby reducing model confidence and transparency.

Therefore, in one embodiment, a prediction system estimates charging features about a battery by training a learning model (e.g., a neural network) through a hybrid approach that combines a physics model with the learning model using early-cycling data. In one approach, the prediction system fits a loss curve associated with capacity using a function for the physics model that is derived from raw data and physically tunes the learning model accordingly. A self-attention layer within the learning model can subsequently reconstruct the loss curve completely using the early-cycling data after additional training. In this way, the learning model predicts a loss curve entirely rather than merely estimating cycle life for a battery and avoids retraining. Furthermore, the training with the physics model brings interpretability and physical intuition for the learning model that increases confidence, such as with end-of-life. Therefore, the prediction system increases the robustness and efficiency of the learning model estimating charging features for a battery through incorporating physical phenomena and increasing interpretability.

In one embodiment, a prediction system for training a learning model to predict a cycling characteristic of a battery using a physics model is disclosed. The prediction system includes a memory storing instructions that, when executed by a processor, cause the processor to derive ground-truth parameters for a loss curve of an actual capacity using a physics model, the actual capacity associated with a battery type. The instructions also include instructions to compare the ground-truth parameters with curve parameters estimated by a self-attention model for physical tuning of the self-attention model, and the curve parameters being associated with a predicted capacity for the battery type. The instructions also include instructions to adjust the self-attention model by comparing predicted cycles from the self-attention model and actual cycles from the physics model for cycle life as additional tuning.

In one embodiment, a non-transitory computer-readable medium for training a learning model to predict a cycling characteristic of a battery using a physics model and including instructions that when executed by a processor cause the processor to perform one or more functions is disclosed. The instructions include instructions to derive ground-truth parameters for a loss curve of an actual capacity using a physics model, the actual capacity associated with a battery type. The instructions also include instructions to compare the ground-truth parameters with curve parameters estimated by a self-attention model for physical tuning of the self-attention model, and the curve parameters being associated with a predicted capacity for the battery type. The instructions also include instructions to adjust the self-attention model by comparing predicted cycles from the self-attention model and actual cycles from the physics model for cycle life as additional tuning.

In one embodiment, a method for training a learning model to predict a cycling characteristic of a battery using a physics model is disclosed. In one embodiment, the method includes deriving ground-truth parameters for a loss curve of an actual capacity using a physics model, the actual capacity associated with a battery type. The method also includes comparing the ground-truth parameters with curve parameters estimated by a self-attention model for physical tuning of the self-attention model, and the curve parameters being associated with a predicted capacity for the battery type. The method also includes adjusting the self-attention model by comparing predicted cycles from the self-attention model and actual cycles from the physics model for cycle life as additional tuning.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a prediction system that is associated with training a learning model to predict a cycling characteristic of a battery using a physics model.

FIG. 3 illustrates one embodiment training the learning model using a hybrid approach involving the physics model.

FIG. 4 illustrates an example of inputs and outputs associated with the learning model.

FIG. 5 illustrates an example of comparing loss curves for battery capacity using ground-truth parameters and predicted curve parameters.

FIG. 6 illustrates one embodiment of a method that is associated with comparing physics-based and predicted parameters about a battery for training a self-attention model.

### DETAILED DESCRIPTION

Systems, methods, and other embodiments associated with training a learning model to predict a cycling characteristic of a battery using a physics model are disclosed herein. In various implementations, systems predicting a cycle life of a battery (e.g., a lithium-ion battery) remains challenging due to side effects from battery chemistry that degrade performance through repeated cycling. For example, solid electrolyte interphase (SEI) formation during the initial cycles of a new battery affects cycle life in the long term. Systems accurately predicting the cycle life while accounting for chemical processes such as SEI are demanded for maintaining device and battery performance. In particular, accurately predicting the cycle life with early-cycling data benefits devices by detecting defects sooner, such as during manufacturing. Furthermore, data-driven models (e.g., linear models, neural networks (NN), vector regression, etc.) although agnostic to chemical degradation confront tuning difficulties by misinterpreting battery phenomena.

Therefore, in one embodiment, a prediction system trains a learning model through a hybrid architecture that combines a physics-based approach with the learning model in stages for predicting a cycling characteristic. Here, a physics model can factor cell chemistry and analyze electrode material changing over time that is captured with a function derived from raw data. In one approach, the prediction system derives ground-truth parameters for a loss curve of an actual battery using the physics model. The prediction system can subsequently compare the ground-truth parameters with curve parameters of a predicted capacity outputted from the learning model for physical tuning. For example, the learning model is a self-attention model that the prediction system trains to learn complex, non-linear relations between the loss curve and other measurements available during early-cycling of a battery. In this way, the physical tuning coarsely trains the learning model through guiding the curve parameters towards ground-truth values derived from the physics model while identifying a relationship with a cycle number.

Upon completing the physical tuning, the prediction system can adjust the self-attention model by comparing predicted cycles from the self-attention model and actual cycles from the physics model for cycle life. In particular, comparing the predicted cycles and the actual cycles trains the self-attention model to finely reduce losses associated with the physical tuning and parameterization. Accordingly, the prediction system improves loss curve predictions through training a learning model with a physics model using a multi-stage approach, thereby improving estimation accuracy during early-cycling of a battery.

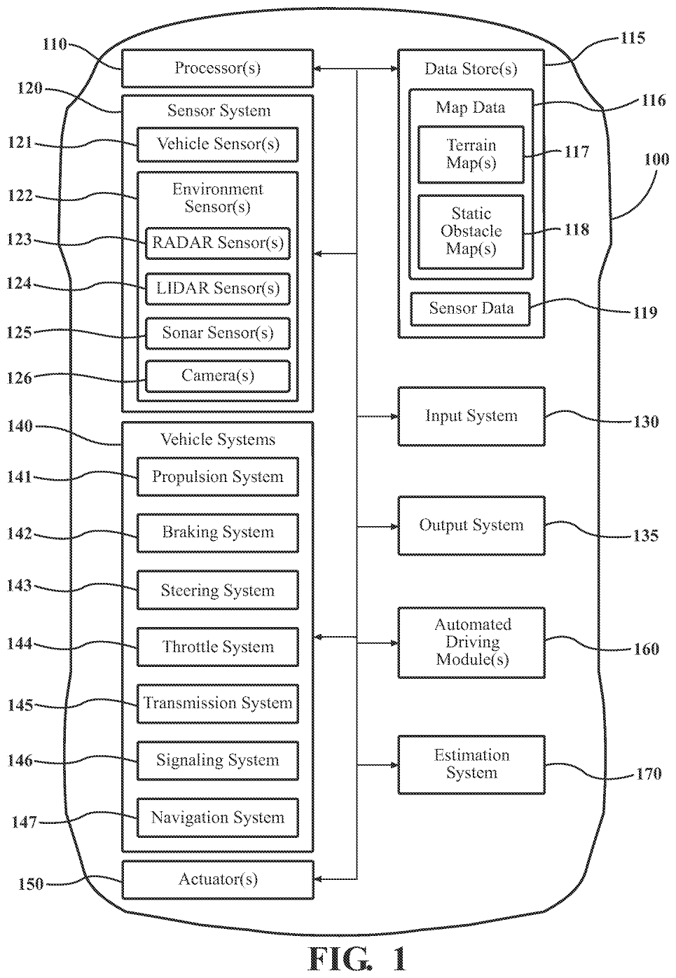

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, an estimation system 170 is implemented within a consumer device, road-side units (RSU), consumer electronics (CE), mobile devices, robots, drones, and so on that benefit from the functionality discussed herein associated with training a learning model to predict a cycling characteristic of a battery using a physics model. Furthermore, the estimation system 170 may include the learning model trained by a prediction system 200 in the examples herein and predict a battery characteristic accordingly.

The vehicle 100 also includes various elements. It will be understood that in various embodiments, the vehicle 100 may have less than the elements shown in FIG. 1. The vehicle 100 can have any combination of the various elements shown in FIG. 1. Furthermore, the vehicle 100 can have additional elements to those shown in FIG. 1. In some arrangements, the vehicle 100 may be implemented without one or more of the elements shown in FIG. 1. While the various elements are shown as being located within the vehicle 100 in FIG. 1, it will be understood that one or more of these elements can be located external to the vehicle 100. Furthermore, the elements shown may be physically separated by large distances.

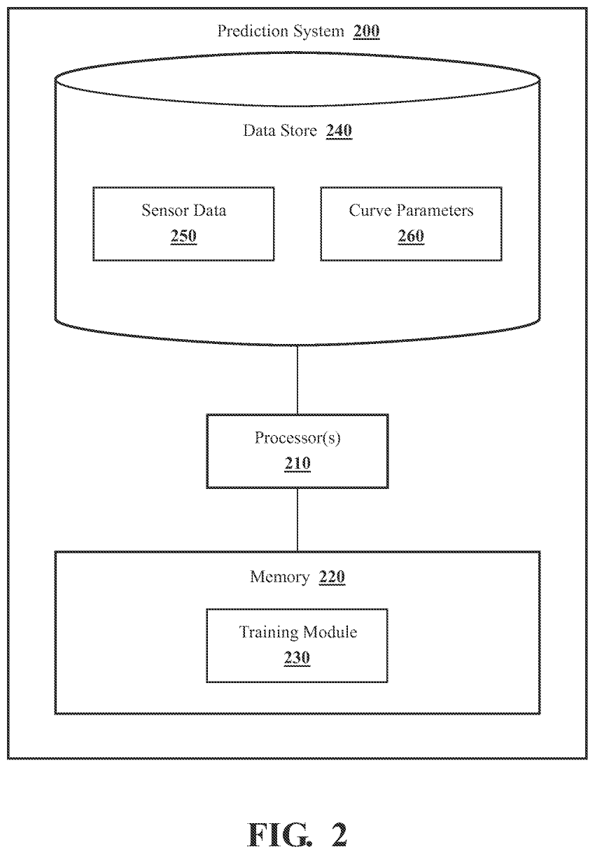

Some of the possible elements of the vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, the vehicle 100 includes an estimation system 170 that is implemented to perform methods and other functions as disclosed herein relating to improving forecasts about cycling characteristics.

With reference to FIG. 2, one embodiment of a prediction system 200 is illustrated. The prediction system 200 is shown as including a processor(s) 210 and a memory 220 that stores a training module 230. The memory 220 is a random-access memory (RAM), a read-only memory (ROM), a hard-disk drive, a flash memory, or other suitable memory for storing the training module 230. The training module 230 is, for example, computer-readable instructions that when executed by the processor(s) 210 cause the processor(s) 210 to perform the various functions disclosed herein.

The prediction system 200 as illustrated in FIG. 2 is generally an abstracted form and may include a data store 240. In one embodiment, the data store 240 is a database. The database is, in one embodiment, an electronic data structure stored in the memory 220 or another data store and that is configured with routines that can be executed by the processor(s) 210 for analyzing stored data, providing stored data, organizing stored data, and so on. Thus, in one embodiment, the data store 240 stores data used by the training module 230 in executing various functions. In one embodiment, the data store 240 includes the sensor data 250 describing charging, discharging, and so on features associated with different battery types. In one embodiment, the data store 240 further includes curve parameters 260 that are constant values associated with a loss curve and cycle life. Here, cycle life may be a number of charge and discharge cycles until the state of health (SoH) drops to or below 80% (e.g., 150 to 2,300 cycles).

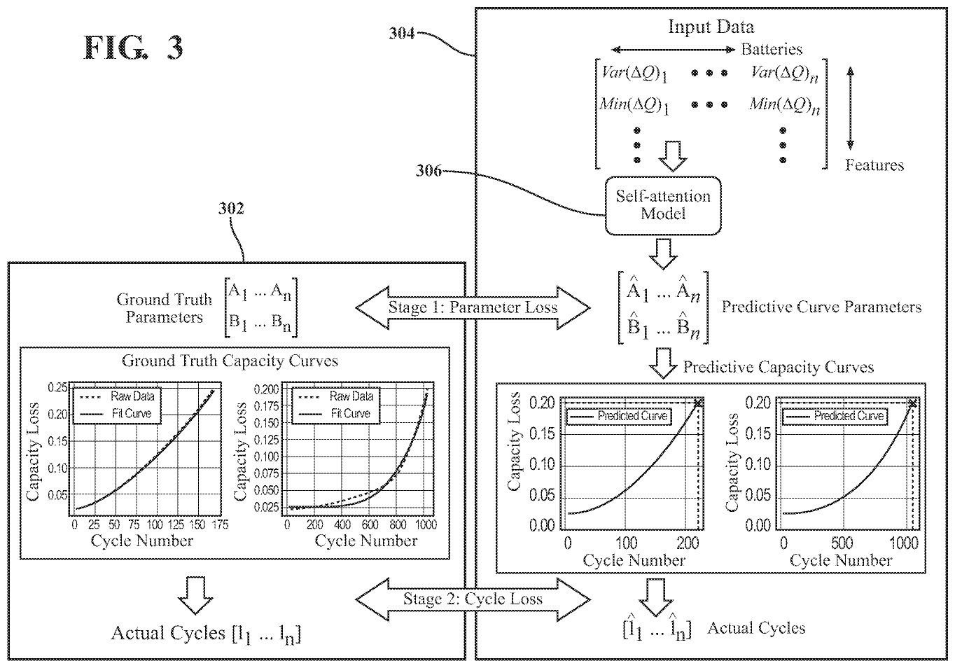

Now turning to FIG. 3, one embodiment of training a learning model using a hybrid approach involving a physics model is illustrated. The prediction system 200 and the training module 230, in one embodiment, include instructions that cause the processor 210 to derive ground-truth parameters for a loss curve of an actual capacity using a physics model 302 that factors thermal degradation and other physical phenomena associated with battery cycling. Here, the actual capacity may be associated with a battery type (e.g., Li-iron graphite). Furthermore, deriving the ground-truth parameter can involve fitting the loss curve using a function derived from battery data that is raw. For example, the prediction system 200 observes and acquires the battery data through cycling random battery cells repeatedly and rapidly until the end-of-life drops towards an effective capacity. The drop may be falling below a certain amount of a nominal capacity (e.g., 80%) for the battery cell and SoH can be the ratio of the effective and nominal capacity.

Moreover, the battery data can include a cycle life, a charge policy, summarized cycle features, and full cycle data for a battery cell. The battery data may also be a time-series (e.g., a partial time-series, a full time-series, etc.) that facilitates data-driven training of a self-attention model 306. Although the examples given herein reference a self-attention model, any learning model that estimates battery characteristics using measured data and trained with a physics model may be implemented. Furthermore, the charge policy can be a schedule of charge rates followed during battery cell cycling. The prediction system 200 can compute summarized cycle features such as SoH, internal resistance (IR), average cell temperature (T_{avg}), and maximum cell temperature (Tₘₐₓ). Additionally, the prediction system 200 can execute measurements and acquire the full cycle data that includes voltage (V), discharged capacity (Q_{d}), and temperature (T) associated with a cycle life prediction. Correspondingly, the prediction system 200 may construct a discharge-voltage curve for a cycle Q_{d}(V) by graphing Q_{d} against V for the discharge portion of the cycle. To standardize the discharge curves and avoid irregular sets caused by voltage variations, the prediction system 200 executes interpolation with a radial basis function (RBF) and smooths irregularly spaced inputs. An interpolant is given by Equation (1):

$${\hat{Q}}_{d} ( V ) = {p}_{m} ( V ) + {\sum }_{i = 1}^{N} {λ}_{i} ϕ ( \vert V - {V}_{i} \vert ) . \qquad Equation ( 1 )$$

In Equation (1), data points are interpolated using a weighted sum of RBFs with the origins at the interpolation nodes Vᵢ, and through pₘ(V)=c₀+c₁V+ . . . +cₘV^{m}, a polynomial of degree m. The coefficients of pₘ and the weights λᵢ can be found by solving a set of linear equations. The form of ϕ controls the interpolant. The polynomial term models possible trends in battery data, which the RBFs may be otherwise unable to achieve with the symmetric, radial nature of RBFs.

In various implementations, the prediction system 200 exploits the evolution of Q_{d}(V) over cycles to estimate cycle life. This can include exploiting sagging of loss curves that occurs with early-cycling for batteries having a limited rather than an extended cycle life. As such, the prediction system 200 captures the sagging through exploiting the discharge-voltage curves for early-cycle numbers (e.g., between 100 and 10) and computing the differences between the early-cycle numbers. For example, the computation for the discharge-voltage curves associated with cycle numbers 100 and 20 is Q_{d,100}(V)−Q_{d,10}(V) and denoted by ΔQ₁₀₀₋₁₀(V). This computation may exhibit that batteries with limited cycle lives have more ample dips in the ΔQ₁₀₀₋₁₀(V) curve. Furthermore, the prediction system 200 calculates statistical quantities, such as the variance, minimum, and mean of ΔQ₁₀₀₋₁₀(V) to condense information about a cycle life for a battery cell. A variance-based model would, for instance, use Var(ΔQ₁₀₀₋₁₀(V)) as an input to predict a cycle life.

Still referring to FIG. 3, the training module 230 can train the self-attention model 306 using a hybrid approach with the physics model 302. Here, the physics model 302 can be formed with utilizing an Arrhenius Law to model loss curves for capacity and utilize self-attention for predicting cycle life from early-cycling data. A self-attention model can be a lightweight network that executes gradient computations that are interpretable, accurate, and efficient. In various implementations, a battery cell experiences impediments to electron movement with chemical processes among early-cycling, such as solid electrode interphase (SEI) formations on anode surfaces. These chemical processes can impact capacity loss and limit cycle life. In one approach, a true capacity loss Qₗₒₛₛ can be approximated as:

$${\hat{Q} ( x )}_{loss} = Bexp ( - \frac{{E}_{a}}{RT} ) {x}^{z} , \qquad Equation ( 2 )$$

for constants B and z. Here, \hat{Q}ₗₒₛₛ represents the percentage of capacity loss, Eₐ is the activation energy, R the gas constant, T the absolute temperature, and x the cycle number. Furthermore, temperature resembles an Arrhenius Law that is associated with chemical processes that are thermally activated, such as SEI formation during cycling. As such, Equation (2) accounts for SEI formation, lithium consumption at the negative electrode, and so on that produces undesired side effects in battery cells and causes capacity loss.

The prediction system 200 can modify Equation (2) for efficiency. For example, predicting In B instead of B mitigates numerical instability and calculation overflows due to large magnitudes associated with B. Treating T as invariant since average temperature between cycles is stable allows incorporating the original exponential factor from Equation (2) into the previously described constant. This has the advantage that Eₐ can be unknown. Furthermore, adopting the addition of a constant C by shifting up predicted curves such that initial points match the first point of the ground-truth loss curve reduces a variable and simplifies curve fitting for capacity loss. As such, Equation (2) is reduced to:

$${\hat{Q} ( x )}_{loss} = {e}^{A} {x}^{B} + Q ( 0 ) . \qquad Equation ( 3 )$$

Equations (3) is a singular and simple model that captures physical phenomena associated with battery physics. The training module 230 can adapt the physics model to output the ground-truth parameters by minimizing errors associated with curve fitting data derived about a battery type. As such, the prediction system 200 can inject parameters from Equation (3) as a physics model into a data-driven model (e.g., a neural network (NN), a self-attention model, etc.) to improve training models for predicting cycle life. Here, A and B are constants of a loss curve that the self-attention model 306 can estimate through training. Here, a best-fit curve using predictions can be used to determine actual cycle lives. Using Equation (4), a cycle life & is the point where \hat{Q}loss ( [symbol] )=0.2 and calculated from the best-fit curve as

$$ℓ = {[ {e}^{- A} ( 0.2 - Q ( 0 ) ) ]}^{1 / B} , \qquad Equation ( 4 )$$

where 0.2 is the threshold for capacity loss indicating an end-of-life.

Using Equation (3), the prediction system 200 can derive ground-truth parameters for physical tuning of the self-attention model 306. Here, Equation (3) is a function having exponential operations that factor the curve parameters and an initial charging capacity. As such, the training module 230 can compare the ground-truth parameters with curve parameters of a predicted capacity generated by the self-attention model. The ground-truth parameters and the curve parameters are similar constants for the function represented by A and B. As further explained below, the training module 230 can guide the self-attention model 306 towards approximations for the curve parameters and identify a relationship between a cycle number and the curve parameters as training.

Since the physical tuning initially by the physics model 302 can be coarse, additional tuning by the training module 230 fine-tunes the self-attention model 306. Here, the additional tuning of the hybrid approach involves training the self-attention model 306 to predict Â and \hat{B} from inputted features (e.g., variance, minimums, etc.) associated with initial and early-cycling (e.g., 100 cycles). In particular, the parameters Â and \hat{B} are predicted when a full loss curve is unknown. For example, the prediction system 200 supplies a model f with a vector x having statistical quantities from early-cycling and outputs variables (Â, \hat{B})=f(x). As illustrated in FIG. 3, a cycle life predicted can be is [symbol] =[e^{-Â}(0.2−C)]^{1/\hat{B}}. The self-attention model 306 can learn complex, non-linear relations between a loss curve and measurements inputted from early-cycling when fitting and extrapolating the full loss curve using least squares is unavailable and unreliable.

Regarding capacity estimates, the prediction system 200 can derive an input sequence of N features from early-cycling for the i-th battery expressed as xᵢ:=[xᵢ⁽¹⁾, . . . , xᵢ^{(N)}]^{T}∈ [symbol] ^{N×1}. The standard query matrix Q, key matrix K, and value matrix V computed with the self-attention model 306 can involve the following transformations:

$$\begin{matrix}{Q}_{i} = {x}_{i} {W}_{Q}^{T} \\ {K}_{i} = {x}_{i} {W}_{K}^{T} \\ {V}_{i} = {x}_{i} {W}_{V}^{T}\end{matrix} , \qquad Equation ( 5 )$$

Here, the weight matrices W_{Q}, W_{K}∈ [symbol] ^{D×1} and W_{V}∈ [symbol] ^{D}^{ᵥ}^{×1} are learnable layers, D is a hyperparameter determining the embedding dimension, and Dᵥ is the output dimension. For example, Dᵥ=2 for a task involving a multi-output regression for predicting two variables. The self-attention model 306 output Hᵢ can be also expressed as:

Hᵢ=softmax(QᵢKᵢ^{T}/\sqrt{D})Vᵢ:=AᵢVᵢ. Equation (6)

In Equation (6), the prediction system 200 can apply a softmax function to a row of the matrix

$$\frac{{Q}_{i} {K}_{1}^{T}}{\sqrt{D}}$$

and obtain the attention matrix Aᵢ. For collapsing the output Hᵢ∈ [symbol] ^{N×D}^{ᵥ} to a vector, an averaging layer appended with the self-attention model 306 takes the mean along the columns of Hᵢ:

$${y}_{i} := {H}_{i}^{T} m = [ \begin{matrix}{\hat{A}}_{i} \\ {\hat{B}}_{i}\end{matrix} ] . \qquad Equation ( 7 )$$

### Here,

$$m = {[ \frac{1}{N} … \frac{1}{N} ]}^{T} ∈ {ℝ}^{N \times 1} .$$

The result yᵢ∈ [symbol] ^{D}^{ᵥ}^{×1} can be the vector of predicted parameters for a loss curve. The prediction system 200 can process the predicted parameters and estimate cycle life using Equation (8):

$${\hat{l}}_{ι} = {[ {e}^{- {\hat{A}}_{i}} ( 0.2 - {C}_{i} ) ]}^{1 / {\hat{B}}_{i}} . \qquad Equation ( 8 )$$

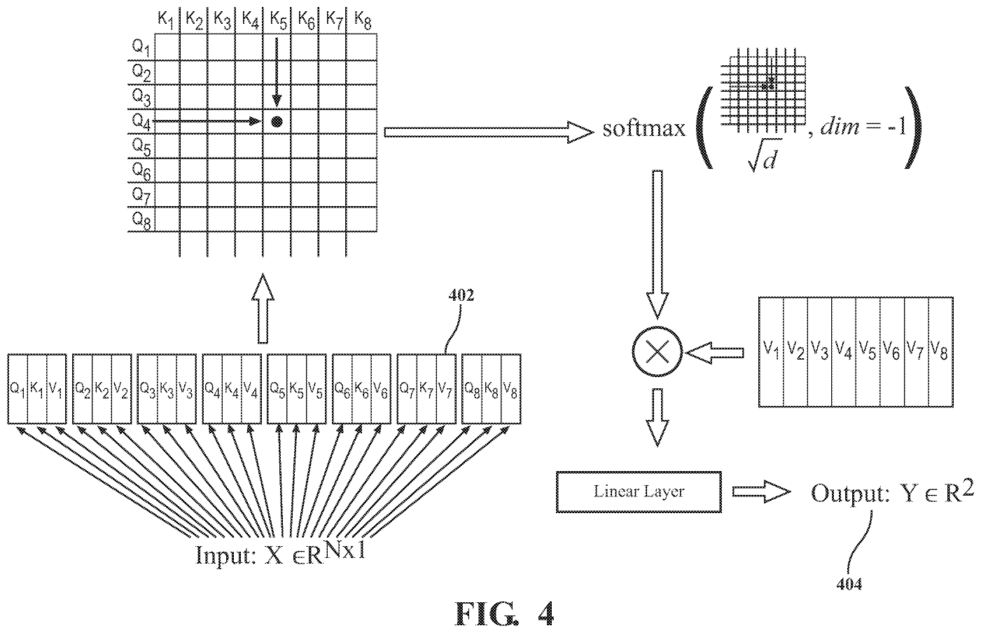

Turning now to FIG. 4, an example of inputs and outputs associated with a learning model that predicts charging characteristics of a battery cell is illustrated. Here, the self-attention model 306 may process the input features 402 and compute the operations described by Equations (5)-(7). The outputted parameters 404 can be the vector of predicted parameters for a loss curve, such as A and B represented by vector Yᵢ. Regarding selecting the input features 402 for training, the self-attention model 306 is given model features associated with actual parameters corresponding and related with the curve parameters. In one approach, the task becomes selecting the features closely related to variables Â and \hat{B} that the self-attention model 306 outputs during training using spearman correlations. As such, the prediction system 200 can analyze the correlation between a feature and output variables. Features having strong positive or negative correlations are prioritized as they are more likely at providing accurate predictions.

Coefficients from spearman correlations can assist the prediction system 200 to ascertain features that are most related with the variables Â and \hat{B}. These coefficients are statistical measures that assess the strength and direction of a monotonic relationship between variables, including non-linear relationships. For example, the training module 230 has the self-attention model 306 learn with the features DeltaQ_logVars, DeltaQ_logMin, DeltaQ_logMean, and slope capacity_fade as inputs associated with a vehicle battery that impact charging. The feature DeltaQ_logVars can be the logarithm of the variance between charge differences from early-cycling for a battery cell. DeltaQ_logMin can be the logarithm of the minimum between charge differences about early-cycling. DeltaQ_logMean can be the logarithm of the mean between charge differences from early-cycling. The input slope capacity_fade can be a slope associated with the linear least-squares best fit to capacity curves between charge differences from early-cycling.

Regarding more details about training, the training module 230 adjusts the self-attention model by comparing predicted cycles from the self-attention model 306 and actual cycles from the physics model for cycle life as additional tuning. For example, the training module 230 minimizes the root mean squared error (RMSE) of cycle life predictions involving a set of n battery cells expressed as:

$${RMSE}_{l} = \sqrt{\frac{1}{n} {\sum }_{i = 1}^{n} {( {l}_{i} - {\hat{l}}_{i} )}^{2}} , \qquad Equation ( 9 )$$

where lᵢ is the true cycle life of the i-th battery cell. For simplification and efficiency, the training module 230 uses two-stages that involve coarse training on curve parameters followed by fine-tuning on cycle life. In the first stage, the prediction system 200 trains on the RMSE of parameter loss, defined as:

$${RMSE}_{p} = \sqrt{\frac{1}{n} {\sum }_{i = 1}^{n} ( {{w}_{A} ( {A}_{i} - {Â}_{i} )}^{2} + {{w}_{B} ( {B}_{i} - {\hat{B}}_{i} )}^{2} )} , \qquad Equation ( 10 )$$

where w_{A} and w_{B} are tunable hyperparameters. This approach can smoothen and reduce numerical issues compared to Equation (6), thereby producing stable results when training from random initialization associated with early-cycling.

Due to the non-linearity of the loss curve, two sets of parameter (e.g., Â and \hat{B}) estimates may incur equal parameter loss but produce substantially different cycle life predictions, thereby reducing prediction accuracy. Consequently, the training module 230 follows coarse training with a fine-tuning stage, such as through a reduced learning rate using cycle life losses. In this way, training with both parameter and cycle loss avoids exploding gradients, inconsistent behavior, and inaccurate results for predicting cycle life. As previously explained, the training module 230 derives chemical structure and breakdown for a battery cell during early-cycling with the physics model 302 and trains the self-attention model 306 accordingly with the first stage. Accordingly, the self-attention model 306 is trained to reduce approximation losses associated with the physical tuning.

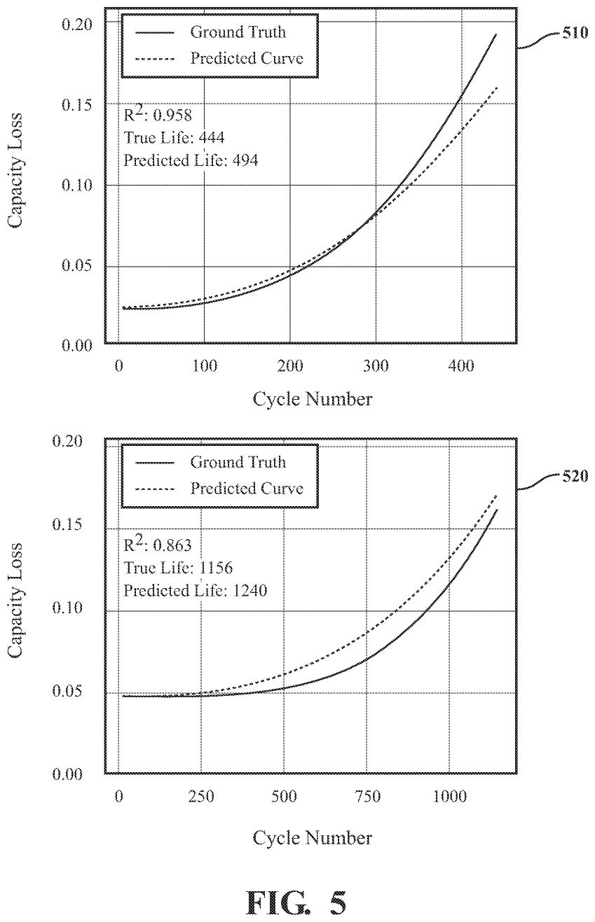

Referring to FIG. 5, an example of comparing loss curves for battery capacity using ground-truth parameters and predicted curve parameters is illustrated. Curve 510 shows the differences between a ground-truth and a predicted curve by the self-attention model 306 during training. Here, curve 510 exhibits a coefficient of determination (R2) for capacity loss predicted by the self-attention model 306 at 0.958, thereby indicating accurate curve fitting. In particular, the true cycling life is 444 while the predicted cycling life is 494. As such, the ground-truth parameters generated with the physics model 302 closely track the predicted parameters. Similarly, curve 520 also illustrates smooth and accurate tracking between a ground-truth and a predicted curve with a tested battery cell. Curve 520 exhibits an R² for capacity loss at 0.863, a true cycling life 1156, and a predicted cycling life 1240.

Regarding using the self-attention model 306 within a device, in one approach, the vehicle 100 implements the self-attention model 306 to predict actual parameters A and B associated with a true cycling life. For example, the self-attention model 306 receives a cycle number and a capacity loss for charge that is measured by the vehicle 100. The actual parameters corresponding to the curve parameters are observed during training with the prediction system 200. Subsequently, the self-attention model 306 reconstructs a loss graph accurately with the actual parameters for any battery cell without the physics model 302, thereby increasing prediction robustness.

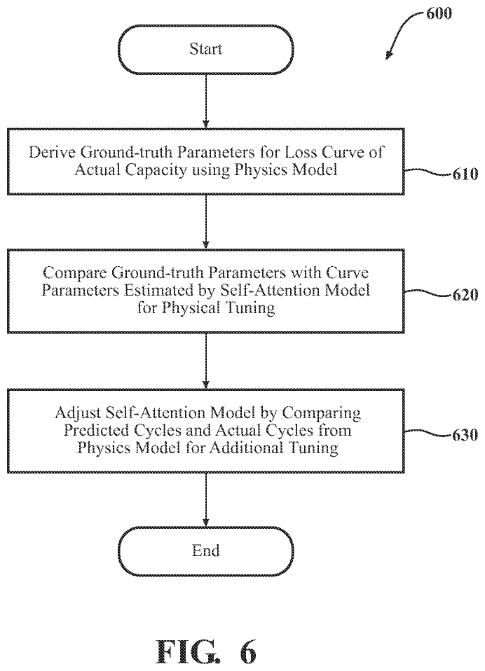

Now turning to FIG. 6, a flowchart of a method 600 that is associated with training a learning model to predict a cycling characteristic about a battery using a physics model is illustrated. Method 600 will be discussed from the perspective of the prediction system 200 of FIG. 2. While method 600 is discussed in combination with the prediction system 200, it should be appreciated that the method 600 is not limited to being implemented within the prediction system 200 but is instead one example of a system that may implement the method 600.

As further explained below, the prediction system 200 trains a learning model with the method 600 to reconstruct loss curves rather than just predicting cycle life with a hybrid approach that combines a physics model and a learning model. In this way, the method 600 increases the robustness and the interpretability of predictions without sacrificing accuracy. In one approach, parameterizing the ground-truth for loss curves associated with a battery cell through fitting Equation (3) and training a self-attention model to recover the parameters allows reconstructing full capacity curves. In this way, the self-attention model can accurately predict cycle life and end-of-life with early-cycling data of the battery cell, such as within the first 50-100 cycles.

At 610, the prediction system 200 derives ground-truth parameters for a loss curve of actual capacity using a physics model. Here, the physics model captures physical phenomena associated with battery physics, chemical structure, and degradation. In one approach, the prediction system 200 utilizes the physics model for curve fitting data about a battery type using Equation (3). A true loss curve is derived by reducing least-squares errors and parameterization for identifying the ground-truth parameters. As such, the prediction system 200 can relate Equation (3) as a physics model into a data-driven model (e.g., a neural network (NN), a self-attention model, etc.) to improve training models for predicting cycle life. Here, A and B are constants of a loss curve that the self-attention model can estimate through training. The self-attention model can predict the constants using a cycle number and a capacity loss for charge that are features measured and observed as inputs.

At 620, the training module 230 compares the ground-truth parameters with curve parameters of predicted capacity from a self-attention model for physical tuning. In one approach, the ground-truth parameters and the curve parameters are similar constants for the function represented by A and B. As previously explained, the training module 230 can guide the self-attention model towards approximations for the curve parameters and identify a relationship between a cycle number and the curve parameters as coarse training. Since the physical tuning of the self-attention model initially by the physics model can be coarse, the training module 230 fine-tunes the self-attention model. In one approach, as previously explained, minimizing cycle losses estimated by the physics model and the self-attention model increases prediction accuracy.

At 630, the training module 230 adjusts the self-attention model by comparing predicted cycles and actual cycles from the physics model for additional tuning. Here, the additional tuning of involves training the self-attention model to predict Â and \hat{B} from inputs associated with initial-cycling (e.g., 100 cycles) without a full loss curve. This additional stage trains the self-attention model to reduce approximation losses associated with the physical tuning during initial training. In particular, the additional stage during training improves prediction accuracy that is impacted by the non-linearity of the loss curve. For example, the non-linearity causes estimates about parameters Â and \hat{B} to exhibit similar losses but produce substantially different predictions for cycle life. Consequently, the training module 230 follows coarse training with a fine-tuning stage using cycle life losses. In one approach, the training module 230 minimizes a RMSE for cycle life predicted by the physics model and the self-attention model involving a battery cell set. In this way, training with both parameter and cycle loss avoids inconsistent and inaccurate results for predicting cycle life. Accordingly, the prediction system 200 improves accuracy and robustness for cycle life predictions by training a self-attention model with a physics model in multiple stages with parameter losses about a loss curve and cycle losses.

FIG. 1 will now be discussed in full detail as an example environment within which the system and methods disclosed herein may operate. In some instances, the vehicle 100 is configured to switch selectively between different modes of operation/control according to the direction of one or more modules/systems of the vehicle 100. In one approach, the modes include: 0, no automation; 1, driver assistance; 2, partial automation; 3, conditional automation; 4, high automation; and 5, full automation. In one or more arrangements, the vehicle 100 can be configured to operate in a subset of possible modes.

In one or more embodiments, the vehicle 100 is an automated or autonomous vehicle. As used herein, “autonomous vehicle” refers to a vehicle that is capable of operating in an autonomous mode (e.g., category 5, full automation). “Automated mode” or “autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the vehicle 100 along a travel route.

The vehicle 100 can include one or more processors 110. In one or more arrangements, the processor(s) 110 can be a main processor of the vehicle 100. For instance, the processor(s) 110 can be an electronic control unit (ECU), an application-specific integrated circuit (ASIC), a microprocessor, etc. The vehicle 100 can include one or more data stores 115 for storing one or more types of data. The data store(s) 115 can include volatile and/or non-volatile memory. Examples of suitable data stores 115 include RAM, flash memory, ROM, programmable read-only memory (PROM), erasable programmable read-only memory (EPROM), electrically erasable programmable read-only memory (EEPROM), registers, magnetic disks, optical disks, and hard drives. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry.

In one or more arrangements, the map data 116 can include one or more terrain maps 117. The terrain map(s) 117 can include information about the terrain, roads, surfaces, and/or other features of one or more geographic areas. The terrain map(s) 117 can include elevation data in the one or more geographic areas. The terrain map(s) 117 can define one or more ground surfaces, which can include paved roads, unpaved roads, land, and other things that define a ground surface.

In one or more arrangements, the map data 116 can include one or more static obstacle maps 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles can include trees, buildings, curbs, fences, railings, medians, utility poles, statues, monuments, signs, benches, furniture, mailboxes, large rocks, or hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

One or more data stores 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information about one or more LIDAR sensors 124 of the sensor system 120.

In some instances, at least a portion of the map data 116 and/or the sensor data 119 can be located in one or more data stores 115 located onboard the vehicle 100. Alternatively, or in addition, at least a portion of the map data 116 and/or the sensor data 119 can be located in one or more data stores 115 that are located remotely from the vehicle 100.

As noted above, the vehicle 100 can include the sensor system 120. The sensor system 120 can include one or more sensors. “Sensor” means a device that can detect, and/or sense something. In at least one embodiment, the one or more sensors detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors may function independently or two or more of the sensors may function in combination. The sensor system 120 and/or the one or more sensors can be operatively connected to the processor(s) 110, the data store(s) 115, and/or another element of the vehicle 100. The sensor system 120 can produce observations about a portion of the environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect information about the vehicle 100 itself. In one or more arrangements, the vehicle sensor(s) 121 can be configured to detect position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect one or more characteristics of the vehicle 100 and/or a manner in which the vehicle 100 is operating. In one or more arrangements, the vehicle sensor(s) 121 can include a speedometer to determine a current speed of the vehicle 100.

Alternatively, or in addition, the sensor system 120 can include one or more environment sensors 122 configured to acquire data about an environment surrounding the vehicle 100 in which the vehicle 100 is operating. “Surrounding environment data” includes data about the external environment in which the vehicle is located or one or more portions thereof. For example, the one or more environment sensors 122 can be configured to sense obstacles in at least a portion of the external environment of the vehicle 100 and/or data about such obstacles. Such obstacles may be stationary objects and/or dynamic objects. The one or more environment sensors 122 can be configured to detect other things in the external environment of the vehicle 100, such as, for example, lane markers, signs, traffic lights, traffic signs, lane lines, crosswalks, curbs proximate to the vehicle 100, off-road objects, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more of: radar sensors 123, LIDAR sensors 124, sonar sensors 125, weather sensors, haptic sensors, locational sensors, and/or one or more cameras 126. In one or more arrangements, the one or more cameras 126 can be high dynamic range (HDR) cameras, stereo, or infrared (IR) cameras.

The vehicle 100 can include an input system 130. An “input system” includes components or arrangement or groups thereof that enable various entities to enter data into a machine. The input system 130 can receive an input from a vehicle occupant. The vehicle 100 can include an output system 135. An “output system” includes one or more components that facilitate presenting data to a vehicle occupant.

The vehicle 100 can include one or more vehicle systems 140. Various examples of the one or more vehicle systems 140 are shown in FIG. 1. However, the vehicle 100 can include more, fewer, or different vehicle systems. It should be appreciated that although particular vehicle systems are separately defined, any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Any of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the estimation system 170, and/or the automated driving module(s) 160 can be operatively connected to communicate with the various vehicle systems 140 and/or individual components thereof. For example, the processor(s) 110 and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140 and, thus, may be partially or fully autonomous as defined by the society of automotive engineers (SAE) levels 0 to 5.

The processor(s) 110, the estimation system 170, and/or the automated driving module(s) 160 can be operatively connected to communicate with the various vehicle systems 140 and/or individual components thereof. For example, the processor(s) 110, the estimation system 170, and/or the automated driving module(s) 160 can be in communication to send and/or receive information from the various vehicle systems 140 to control the movement of the vehicle 100. The processor(s) 110, the estimation system 170, and/or the automated driving module(s) 160 may control some or all of the vehicle systems 140.

The processor(s) 110, the estimation system 170, and/or the automated driving module(s) 160 may be operable to control the navigation and maneuvering of the vehicle 100 by controlling one or more of the vehicle systems 140 and/or components thereof. For instance, when operating in an autonomous mode, the processor(s) 110, the estimation system 170, and/or the automated driving module(s) 160 can control the direction and/or speed of the vehicle 100. The processor(s) 110, the estimation system 170, and/or the automated driving module(s) 160 can cause the vehicle 100 to accelerate, decelerate, and/or change direction. As used herein, “cause” or “causing” means to make, force, compel, direct, command, instruct, and/or enable an event or action to occur or at least be in a state where such event or action may occur, either in a direct or indirect manner.

The vehicle 100 can include one or more actuators 150. The actuators 150 can be an element or a combination of elements operable to alter one or more of the vehicle systems 140 or components thereof responsive to receiving signals or other inputs from the processor(s) 110 and/or the automated driving module(s) 160. For instance, the one or more actuators 150 can include motors, pneumatic actuators, hydraulic pistons, relays, solenoids, and/or piezoelectric actuators, just to name a few possibilities.

The vehicle 100 can include one or more modules, at least some of which are described herein. The modules can be implemented as computer-readable program code that, when executed by a processor(s) 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processors 110. Alternatively, or in addition, one or more data stores 115 may contain such instructions.

In one or more arrangements, one or more of the modules described herein can include artificial intelligence elements, e.g., neural network, fuzzy logic, or other machine learning algorithms. Furthermore, in one or more arrangements, one or more of the modules can be distributed among a plurality of the modules described herein. In one or more arrangements, two or more of the modules described herein can be combined into a single module.

The vehicle 100 can include one or more automated driving modules 160. The automated driving module(s) 160 can be configured to receive data from the sensor system 120 and/or any other type of system capable of capturing information relating to the vehicle 100 and/or the external environment of the vehicle 100. In one or more arrangements, the automated driving module(s) 160 can use such data to generate one or more driving scene models. The automated driving module(s) 160 can determine position and velocity of the vehicle 100. The automated driving module(s) 160 can determine the location of obstacles, obstacles, or other environmental features including traffic signs, trees, shrubs, neighboring vehicles, pedestrians, etc.

The automated driving module(s) 160 can be configured to receive, and/or determine location information for obstacles within the external environment of the vehicle 100 for use by the processor(s) 110, and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The automated driving module(s) 160 either independently or in combination with the estimation system 170 can be configured to determine travel path(s), current autonomous driving maneuvers for the vehicle 100, future autonomous driving maneuvers and/or modifications to current autonomous driving maneuvers based on data acquired by the sensor system 120, driving scene models, and/or data from any other suitable source such as determinations from the sensor data 250. “Driving maneuver” means one or more actions that affect the movement of a vehicle. Examples of driving maneuvers include: accelerating, decelerating, braking, turning, moving in a lateral direction of the vehicle 100, changing travel lanes, merging into a travel lane, and/or reversing, just to name a few possibilities. The automated driving module(s) 160 can be configured to implement determined driving maneuvers. The automated driving module(s) 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The automated driving module(s) 160 can be configured to execute various vehicle functions and/or to transmit data to, receive data from, interact with, and/or control the vehicle 100 or one or more systems thereof (e.g., one or more of vehicle systems 140).

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-6 but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A prediction system comprising:
a memory storing instructions that, when executed by a processor, cause the processor to:
derive ground-truth parameters for a loss curve of an actual capacity using a physics model, the actual capacity associated with a battery type;
compare the ground-truth parameters with curve parameters estimated by a self-attention model for physical tuning of the self-attention model, and the curve parameters being associated with a predicted capacity for the battery type; and
adjust the self-attention model by comparing predicted cycles from the self-attention model and actual cycles from the physics model for cycle life as additional tuning.

2. The prediction system of claim 1, wherein the instructions to derive the ground-truth parameters further include instructions to:
fit the loss curve using a function derived from battery data that is raw, the function having exponential operations that factor the curve parameters and an initial charging capacity, and the ground-truth parameters and the curve parameters being similar constants for the function.

3. The prediction system of claim 1, wherein the instructions to compare the ground-truth parameters further include instructions to:
guide the self-attention model towards approximations for the curve parameters; and
identify a relationship between a cycle number and the curve parameters.

4. The prediction system of claim 1, wherein the instructions to adjust the self-attention model further include instructions to:
train the self-attention model to reduce approximation losses associated with the physical tuning.

5. The prediction system of claim 4 further including instructions to:
predict actual parameters by the self-attention model associated with a battery cell using a cycle number and a capacity loss for charge that are measured, the actual parameters corresponding to the curve parameters and the self-attention model executing computations without the physics model; and
reconstruct a loss graph with the actual parameters.

6. The prediction system of claim 1 further including instructions to:
adapt the physics model to output the ground-truth parameters by minimizing errors, wherein the physics model numerically represents a physical structure and a chemical structure about the battery type.

7. The prediction system of claim 1 further including instructions to:
select by the self-attention model features associated with actual parameters corresponding to the curve parameters during training using spearman correlations.

8. The prediction system of claim 1, wherein inputs to the self-attention model are one of a charge variance, a minimum charge, a mean charge, and a slope of a fade curve associated with a vehicle battery.

9. The prediction system of claim 1, wherein the physics model factors thermal degradation and the additional tuning is data-driven using acquired battery data.

10. A non-transitory computer-readable medium comprising:
instructions that when executed by a processor cause the processor to:
derive ground-truth parameters for a loss curve of an actual capacity using a physics model, the actual capacity associated with a battery type;
compare the ground-truth parameters with curve parameters estimated by a self-attention model for physical tuning of the self-attention model, and the curve parameters being associated with a predicted capacity for the battery type; and
adjust the self-attention model by comparing predicted cycles from the self-attention model and actual cycles from the physics model for cycle life as additional tuning.

11. A method comprising:
deriving ground-truth parameters for a loss curve of an actual capacity using a physics model, the actual capacity associated with a battery type;
comparing the ground-truth parameters with curve parameters estimated by a self-attention model for physical tuning of the self-attention model, and the curve parameters being associated with a predicted capacity for the battery type; and
adjusting the self-attention model by comparing predicted cycles from the self-attention model and actual cycles from the physics model for cycle life as additional tuning.

12. The method of claim 11, wherein deriving the ground-truth parameters further includes:
fitting the loss curve using a function derived from battery data that is raw, the function having exponential operations that factor the curve parameters and an initial charging capacity, and the ground-truth parameters and the curve parameters being similar constants for the function.

13. The method of claim 11, wherein comparing the ground-truth parameters further includes:
guiding the self-attention model towards approximations for the curve parameters; and
identifying a relationship between a cycle number and the curve parameters.

14. The method of claim 11, wherein adjusting the self-attention model further includes:
training the self-attention model to reduce approximation losses associated with the physical tuning.

15. The method of claim 14 further comprising:
predicting actual parameters by the self-attention model associated with a battery cell using a cycle number and a capacity loss for charge that are measured, the actual parameters corresponding to the curve parameters and the self-attention model executing computations without the physics model; and
reconstructing a loss graph with the actual parameters.

16. The method of claim 11 further comprising:
adapting the physics model to output the ground-truth parameters by minimizing errors, wherein the physics model numerically represents a physical structure and a chemical structure about the battery type.

17. The method of claim 11 further comprising:
selecting by the self-attention model features associated with actual parameters corresponding to the curve parameters during training using spearman correlations.

18. The method of claim 11, wherein inputs to the self-attention model are one of a charge variance, a minimum charge, a mean charge, and a slope of a fade curve associated with a vehicle battery.

19. The method of claim 11, wherein the physics model factors thermal degradation and the additional tuning is data-driven using acquired battery data.

20. The method of claim 11, wherein the physical tuning includes coarsely training the self-attention model and the additional tuning is fine-tuning the self-attention model.
